(19) United States
(12) Patent Application Publication
(10) Pub. No.: US 2004/0033068 A1
(43) Pub. Date: Feb. 19, 2004

(54) Heating type light source apparatus

(75) Inventors: Han-Ping Kuo, Taipei (TW); Che-Chih Chang, Taichung (TW)

Correspondence Address: BRUCE H. TROXELL, SUITE 1404, 5205 LEESBURG PIKE, FALLS CHURCH, VA, 22041, US

(73) Assignee: AU Optronics Corporation

(21) Appl. No.: 10/397,218

(22) Filed: Mar. 27, 2003

(30) Foreign Application Priority Data
Aug. 16, 2002 (TW) 091212756

(51) Int. Cl. G02B 17/00

(52) U.S. Cl. 392/424

(57) ABSTRACT

A heating type light source apparatus includes a light tube and a reflector covering the light tube. The outer side of the reflector is provided with an electrical heating device and the electrical heating device is associated with and controlled by a heating circuit.

### BACKGROUND OF THE INVENTION

1. Field of the Invention

The present invention relates to a heating type light source apparatus.

2. Description of Related Art

It is for years that the liquid crystal display has been acted as an information display and it is widely be used in information products. The principle for operating the liquid crystal display is a light source, which is a cold cathode fluorescent light (CCFL), is guided out with a light guide plate. The CCFL is filled with mercury ions such that it can form a light source after being powered on.

The liquid crystal display is used for a computer and portable personal information product traditionally. Basically, it is operated indoor under a condition of normal temperature so that the light source starting and the luminosity of the light source can be expected. In other words, it is capable of satisfying and complying to the need of product design in case of simply using the CCFL.

Due to product application field getting expansion, for instance, the display of GPS, the climate requirement fronted by application field is much more strict. Taking being mounted in a car as an example, the LCD faces a strict trial in an extremely cold area because of the mercury ions in the CCFL becoming inactive under low temperature. As a result, the light tube is not easy to be excited after being powered on so that the lightness obtained is incapable of reaching the required luminosity quickly as it does under the normal temperature.

Accordingly, in order to improve the deficiency, the Japanese patent application laid open No. 11-306832, entitled “BACK LIGHT APPARATUS WITH HEATER”, disclosed a heater is provided on the light source, i.e., light tube or is coiled around the light tube. Although the preceding heater has a function of heating up the light tube, the light tube is made of glass so that the coefficient of conduction is not higher than metal and the light tube is locally heated up so that the mercury ions are distributed unevenly to influence the light emission efficiency and the life span of the light tube.

### SUMMARY OF THE INVENTION

The crux of the present invention is to provide a heating type light source apparatus includes a light tube and a reflector covering the light tube. The outer side of the reflector is provided with an electrical heating device and the electrical heating device is associated with and controlled by a heating circuit. Accordingly, the light tube can be heated up evenly and is free from the unfavorable phenomenon with regard to harming the life span of the light tube.

### BRIEF DESCRIPTION OF THE DRAWINGS

The present invention can be more fully understood by reference to the following description and accompanying drawings, in which:

FIG. 1 is a sectional view of a conventional display module without heating device; and

FIG. 2 is a sectional view of a heating type light source apparatus according to the present invention.

### DETAILED DESCRIPTION OF THE PREFERRED EMBODIMENT

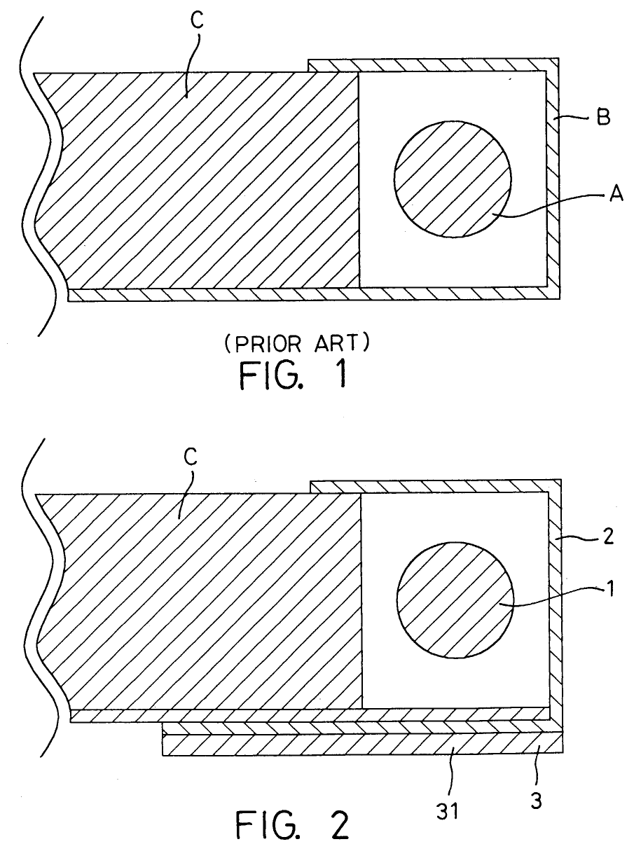

Referring to FIG. 1, a basic structure of the current used display module is illustrated. Wherein, a cold cathode fluorescent light tube (CCFL) A is sealed in a reflector B and the reflector B is associated with a light guide plate C. Thus, the light is reflected completely by the reflector B as soon as the cold cathode tube A is lit up so that the light emitted directly from the cold cathode A can be guided to the guide light plate C and the needed luminous flux density can be displayed. When the cold cathode tube A is started at a low temperature, the luminosity is hard to be increase in short time.

Referring to 2, an embodiment of the present invention is illustrated. A heating type light source apparatus of the present invention basically includes a cold cathode tube 1, a reflector 2 and an electrical heating device 3.

Wherein, the cold cathode tube 1 and the reflector 2 belong to the prior art. The reflector 2 is made of metallic material with the inner surface, i.e., the surface thereof facing the cold cathode tube 1 being coated with reflective material such as aluminum foil evaporation.

The difference of the present invention from the prior art is that an electrical heating device is added. FIG. 2 shows that the reflector 2 at the outer side thereof provides at least an electrical heating plate 31 with a heating circuit 32 (not shown) being joined to the power source, which may be the same power source for the cold cathode tube 1 so as to power on the electrical heating circuit 32 and the cold cathode tube 1 simultaneously. Besides, in order to provide a function of being off automatically, the heating circuit 32 can be added with a function of constant temperature cutout or an over driving voltage or current device for the light tube can be arranged additionally to avoid extraordinary current at the time of the required luminosity being reached and to increase the voltage of the light tube for enhancing the performance of the light tube at the low temperature. Because the preceding added functions are conventional art, no detail will be described further. FIG. 2 shows the electrical heating plate 31 is mounted under the reflector 2 and it is only an example in practice not a limitation. Actually, the electrical heating plate 31 can be disposed over the reflector 2 or behind the light tube.

Referring to FIG. 2 again, while the heating type light source apparatus of the present invention is in use, the cold cathode tube 1 and the electrical heating device can be actuated simultaneously as soon as the power source is on. The heat is transmitted to the reflector 2 and then radiated to an area between the cold cathode tube 1 and the reflector 2. Therefore, the mercury ions in the cold cathode tube 1 become active to increase the luminosity of the cold cathode tube 1 in short time, and led to solve the problem of insufficient luminosity effectively. Furthermore, the power for the electrical heating device 31 will be turned off at the time of the preset temperature being reached; meanwhile, the cold cathode tube 1 has kept in a state of normal luminosity already after the electrical heating device 31 ceasing work.

It is appreciated that heating type light source apparatus according to the present invention can be advantageously free from the unfavorable phenomenon with regard to harming the life span of the light tube.

While the invention has been described with reference to preferred embodiments thereof, it is to be understood that modifications or variations may be easily made without departing from the spirit of this invention, which is defined by the appended claims.

What is claimed is:

1. A heating type light source apparatus comprising:
a light tube; and
a reflector covering the light tube;
characterized in that an outer side of the reflector is provided with an electrical heating device and the electrical heating device is associated with and controlled by a heating circuit.

2. The heating type light source apparatus as defined in claim 1, wherein the electrical heating plate is disposed under the reflector.

3. The heating type light source apparatus as defined in claim 1, wherein the heating circuit is a constant temperature cutout.

4. The heating type light source apparatus as defined in claim 1, wherein the heating circuit is in conjunction with a over driving voltage or current of the light tube.
